(19) United States
(12) Patent Application Publication
(10) Pub. No.: US 2006/0224867 A1
(43) Pub. Date: Oct. 5, 2006

(54) Avoiding unnecessary processing of predicated instructions

(75) Inventor: Thang Minh Tran, Austin, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/095,681

(22) Filed: Mar. 31, 2005

(51) Int. Cl. G06F 9/44

(52) U.S. Cl. 712/226

(57) ABSTRACT

A processor comprising an instruction cache module adapted to store a plurality of instructions, the plurality of instructions comprising a group of instructions predicated on a conditional statement. The processor also comprises a branch prediction module coupled to the instruction cache module and adapted to predict an outcome of the conditional statement. Based on the prediction, the branch prediction module modifies an instruction preceding the group of instructions such that at least one instruction in the group of instructions is not executed.

### BACKGROUND

Battery-operated systems, such as wireless devices (e.g., personal digital assistants, mobile phones), contain processors. Processors, in turn, store machine-executable code (e.g., software). A processor executes some or all portions of the machine-executable code to perform some or all of the functions of the battery-operated system. For example, a processor stored in a mobile phone may execute code that causes the mobile phone to play an audible ring tone or display a particular graphical image. Because battery-operated systems operate on a limited supply of power from the battery, it is desirable to optimize the efficiency of code execution such that battery life is extended.

### SUMMARY

The problems noted above are solved in large part by an apparatus for avoiding the unnecessary fetching and processing of predicated instructions and a method for performing the same. One illustrative embodiment may be a processor comprising an instruction cache module adapted to store a plurality of instructions, the plurality of instructions comprising a group of instructions predicated on a conditional statement. The processor also comprises a branch prediction module coupled to the instruction cache module and adapted to predict an outcome of the conditional statement. Based on the prediction, the branch prediction module modifies an instruction preceding the group of instructions such that at least one instruction in the group of instructions is not executed.

Another illustrative embodiment may be a system comprising a transceiver and a processor coupled to the transceiver. The processor comprises a cache module adapted to store a plurality of consecutive instructions, a group of the plurality of consecutive instructions predicated on at least one condition. The processor also comprises a prediction module coupled to the cache module, the prediction module adapted to predict the status of the at least one condition and, based on the prediction, to determine whether to skip over at least some of the group.

Yet another illustrative embodiment may be a method that comprises predicting the outcome of a conditional statement contained within a predicated instruction and, based on the prediction, determining whether to skip over at least part of a group of predicated instructions all predicated on the conditional statement.

### BRIEF DESCRIPTION OF THE DRAWINGS

For a detailed description of exemplary embodiments of the invention, reference will now be made to the accompanying drawings in which:

FIG. 1 shows a series of instructions on which the technique described herein may be implemented, in accordance with a preferred embodiment of the invention;

FIG. 2 shows a block diagram of a processor system that may be used to implement the technique described herein, in accordance with embodiments of the invention;

FIG. 3 shows a flow diagram of the technique described herein, in accordance with a preferred embodiment of the invention;

FIG. 4 shows another series of instructions on which the technique described herein may be implemented, in accordance with embodiments of the invention; and

FIG. 5 shows a wireless device that may contain the processor system of FIG. 2, in accordance with embodiments of the invention.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. Also, the terms “testing” and “determining the status of” are considered substantially equivalent and may be used interchangeably. Further, the term “preceding” may mean “prior to” and, in some cases, may mean “immediately prior to.” Similarly, the term “succeeding” may mean “after” and, in some cases, may mean “immediately after.”

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

A processor system generally stores instructions in an instruction cache prior to processing the instructions. When the processor is ready to process the instructions, the instructions are fetched from the instruction cache and are transferred to a pipeline. The pipeline generally is responsible for decoding and executing the instructions and storing results of the instructions in a suitable storage unit, such as a register or a memory.

An instruction that is combined with a conditional statement is known as a predicated instruction. The instruction may be executed, but the result of the instruction is not committed to memory (or a register) unless the conditional statement is true (or, in some embodiments, unless the conditional statement is false). In many cases, the conditional statement is based on the status of one or more bits of the processor's condition code register (CCR). Although the composition of CCRs vary from processor to processor, in at least some embodiments, the CCR may comprise one or more of the bits shown below:

| CCR Bit | Description |
|---|---|
| Bit N | the “negative bit;” is set when the result of |
| | an operation results in a negative value |
| Bit Z | the “zero bit;” is set when the result of an |
| | operation results in a zero |
| Bit C | the “carry bit;” is set when an arithmetic |
| | operation caused a “1” bit to be shifted out |
| | of a most-significant bit |
| Bit V | the “overflow bit;” is set when a bit has |
| | been shifted into the most-significant bit |
| | position |

For example, a conditional statement in a predicated instruction may require that the status of the C bit (i.e., the carry bit) in the CCR be set to “1” in order for the results of the associated instruction to be committed to memory (or to some other storage unit). Thus, although the instruction may have been executed, if the C bit in the CCR is not set to “1,” then the results of the instruction are not stored, and the processor effectively wasted time and power executing that instruction.

In many cases, the instruction cache may contain several predicated instructions in a row. At least some of these predicated instructions may comprise identical or substantially similar conditional statements. For example, in the instruction cache, each of three consecutive, predicated instructions may contain a conditional statement identical to those of the other two predicated instructions. More specifically, continuing with this example, the first of the three consecutive, predicated instructions may have a conditional statement that requires bit V of the CCR to be set to “0.” Likewise, the second of the three predicated instructions may have a conditional statement that requires bit V of the CCR to be set to “0.” Similarly, the third predicated instruction may have a conditional statement that requires bit V of the CCR to be set to “0.”

For each predicated instruction, a processor may decode and execute the predicated instruction, and then may store the result of the execution if the bit V of the CCR is set to “0.” As such, the processor checks the status of bit V each time one of the three predicated instructions is executed. However, because the three predicated instructions are consecutive, there are no other instructions present therebetween that may alter the status of bit V. Thus, the technique described further below is made possible by the realization that it is unnecessary for the processor to determine the status of bit V each time one of the three predicated instructions is executed, since the status of bit V remains unchanged. Such unnecessary testing of bit V (or in other embodiments, the testing of any bit of the CCR or any other suitable value) causes the processor to waste both time and power.

Accordingly, disclosed herein is a technique that substantially reduces the time and power loss caused by the repeated testing of substantially identical conditional statements (i.e., repeated testing of the same CCR bit) and the repeated execution of instructions associated therewith in a group of consecutive, predicated instructions. As previously mentioned, the technique is at least partially based on the realization that repeatedly testing the conditional statement of each of the consecutive, predicated instructions is unnecessary, since the same CCR bit is tested in each of the conditional statements. Accordingly, it is further realized that testing the CCR bit only once may suffice. Thus, the technique described herein comprises predicting the status of the CCR bit before the predicated instructions are executed, and based on the prediction, either executing all of the predicated instructions or skipping all of the predicated instructions. In this way, if the status of the CCR bit is such that the results of the predicated instructions ordinarily would not be committed to storage, then time and power is saved by skipping over the predicated instructions altogether, and performance is improved. Conversely, if the status of the CCR bit is such that the results of the predicated instructions would indeed be committed to storage, then the predicated instructions may be executed.

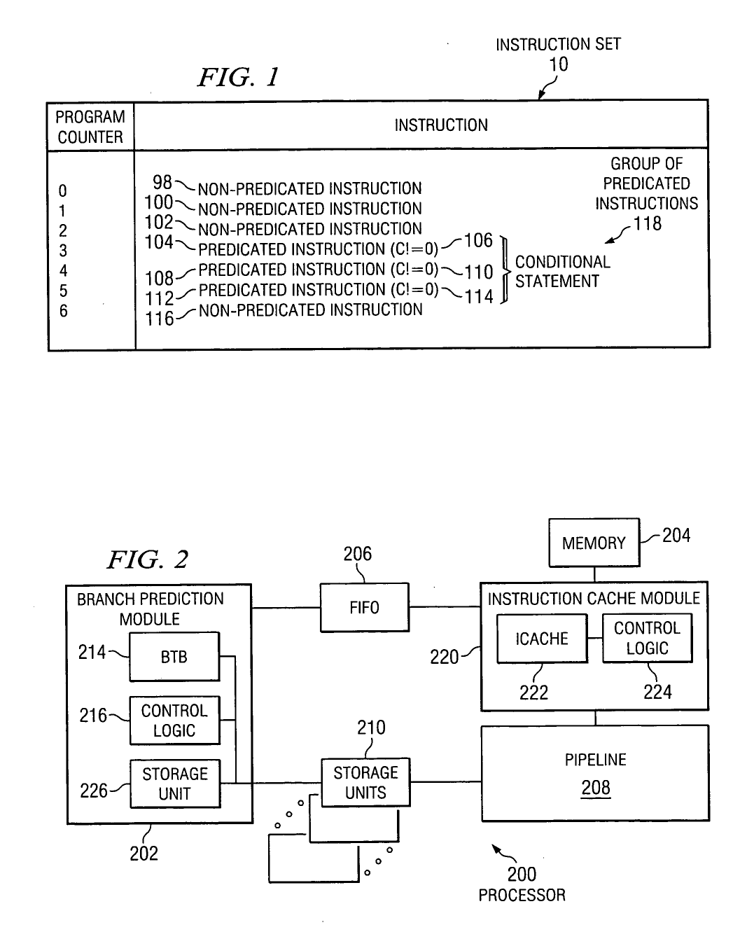

The technique is better illustrated in context of the instruction set shown in FIG. 1. Specifically, FIG. 1 shows a table comprising an instruction set 10. The instruction set 10 may be self-contained or may be part of a larger set of executable instructions. The instruction set 10 may be processed multiple times (i.e., the instruction set 10 may be subject to multiple iterations) because, for instance, the instruction set 10 may be part of an iterative loop. The instruction set 10 may be located in, for example, an instruction cache (shown in FIG. 2 and described below). The instruction set 10 may comprise, among other instructions, a series of non-predicated instructions 98, 100, 102 corresponding to program counters “0,” “1” and “2,” respectively. The instruction set 10 may further comprise a first predicated instruction 104 having a conditional statement 106 and corresponding to a program counter “3,” a second predicated instruction 108 having a conditional statement 110 and corresponding to a program counter “4,” and a third predicated instruction 112 having a conditional statement 114 and corresponding to a program counter “5.” Finally, instruction set 10 comprises a non-predicated instruction 116 corresponding to a program counter “6.” The predicated instructions 104, 108, 112 collectively comprise a group of predicated instructions 118. As shown in the figure, conditional statements 106, 110, 114 are identical, each testing whether the carry bit (i.e., bit C) of the CCR is not equal to zero. The conditional statements 106, 110, 114 are true when the C bit does not equal zero. Otherwise, they are false.

The instruction set 10 may be stored and processed by a processor such as that shown in FIG. 2. Referring to FIG. 2, a processor 200 preferably comprises a branch prediction module 202, a FIFO 206, an instruction cache module 220, a memory 204, a pipeline 208 and storage units 210. The branch prediction module 202 comprises a branch target buffer (BTB) 214, a storage unit 226 and a control logic 216 capable of controlling the BTB 214, the storage unit 226 and any other aspects of the branch prediction module 202 as well as interacting with other components of the processor 200 external to the module 202. The instruction cache module 220 comprises an instruction cache (icache) 222 and a control logic 224 capable of controlling the icache 222 and other aspects of the instruction cache module 220 as well as interacting with other components of the processor 200 external to the module 220.

The instruction set 10 may be stored in the icache 222. The instructions in the instruction set 10 may be fetched, one by one, and transferred into the pipeline 208 for decoding and execution. The BTB 214 may store, among other things, data that enables the control logic 216 to perform branch predictions on instructions stored in the icache 222. Although branch prediction is known to those of ordinary skill in the art, further information on branch prediction is disclosed in “Method and System for Branch Prediction,” U.S. Pat. No. 6,233,679, which is incorporated herein by reference. The control logic 216 also may be able to determine characteristics of instructions stored in the icache 222 before the instructions are even fetched out of the icache 222. For example, the control logic 216 may be able to determine which CCR bit is to be tested in the conditional statement of a predicated instruction that is stored in the icache 222.

As previously mentioned, the instruction set 10 may, in some embodiments, be processed multiple times (i.e., may be part of a loop). In at least some embodiments, the technique mentioned above comprises, on a first iteration through the instruction set 10, storing various data into the module 202, as described below. More specifically, in a first iteration through the instruction set 10, the technique may comprise storing the program counter of the non-predicated instruction immediately preceding the group 118 (i.e., program counter “2” of non-predicated instruction 102) in the BTB 214, for reasons described further below. The program counter of the non-predicated instruction immediately preceding the group 118 may be recognized to be as such by storing program counters of each instruction in the instruction set 10 in a storage unit 210 (e.g., a register) as execution progresses through instruction set 10. The register may store any number of program counters. When decoding and/or execution reaches the group of predication instructions 118, the program counter of the instruction immediately preceding the group 118 is retrieved from the storage unit 210 and is stored to the BTB 214. In the illustrative instruction set 10, the program counter “2” of non-predicated instruction 102 is retrieved from the storage unit 210 and is stored to the BTB 214.

The first iteration of the instruction set 10 further comprises assigning a branch bias value to the conditional statement “(C!=0)” as found in conditional statements 106, 110, 114. The branch bias value is a value that indicates, based on previous iterations of the same instructional code (e.g., the instruction set 10), the likelihood that a particular conditional statement will be true or false. The branch bias value then is stored into the storage unit 226 so that the control logic 216 may use the bias value when performing branch predictions. For example, in a first iteration of the instruction set 10, after the pipeline 208 has finished executing the predicated instruction 104, the pipeline 208 may determine whether the conditional statement 106 is true or false by determining the status of bit C. If the status of bit C is a “0,” then the conditional statement 106 is false, and the result of the predicated instruction 104 is not committed to storage. Conversely, if the status of bit C is a “1,” then the conditional statement 106 is true, and the result of predicated instruction 104 is committed to memory. Regardless of the status of bit C, the conditional statement 106 is assigned a branch bias value by the pipeline 208. Any suitable branch bias value assignment scheme may be used. In the former example, where bit C was a “0,” the branch bias value (which may be a two-bit value) assigned to the conditional statement 106 (and thus also to identical conditional statements 108, 112) may be a “1 0,” indicating that the result of the predication instruction 104 was not committed to storage, and that in future iterations, the predicated instruction 104 probably may be skipped or “branched over.” In the latter example, where bit C was a “1,” the branch bias value assigned to the conditional statement 106 (and also to identical conditional statement 108, 112) may be a “0 0,” indicating that the result of the predicated instruction 104 was indeed committed to storage, and that in future iterations, the predicated instruction 104 probably should not be skipped or “branched over.”

Branch bias values may be assigned using any of a variety of schemes (e.g., global history prediction). One such scheme, bimodal branch prediction, is as follows:

| Branch | |
|---|---|
| bias | |
| value | Definition |
| 0 1 | “Strongly not skipped,” meaning that the predicated |
| | instruction should not be skipped in future iterations |
| 0 0 | “Weakly not skipped,” meaning that the predicated |
| | instruction probably should not be skipped in future iterations |
| 1 0 | “Weakly skipped,” meaning that the predicated |
| | instruction probably should be skipped in future iterations |
| 1 1 | “Strongly skipped,” meaning that the predicated |
| | instruction should be skipped in future iterations |

As such, during the first iteration and after executing conditional statement 106, the conditional statement (C!=0), as shown in conditional statements 106, 110, 114, may be assigned a branch bias value of “0 0” or “1 0,” depending on the status of bit C. During execution of conditional statement 110, however, the branch bias value may be modified. For example, if the branch bias value of the conditional statement (C!=0) is set to “1 0” after execution of conditional statement 106, and if during execution of conditional statement 110 the status of bit C again is determined to be “1,” then the branch bias value may change from “1 0” (weakly skipped) to “1 1” (strongly skipped). Branch bias values are stored in the storage unit 226, so that the control logic 216 may use the bias values for branch predictions in future iterations, as described further below.

In addition to determining branch bias values, the technique comprises, in the first iteration, storing into the BTB 214 the program counter of a non-predicated instruction that follows the group 118: This non-predicated instruction preferably is the first non-predicated instruction following group 118. Referring to FIG. 1, for example, the program counter “6” of non-predicated instruction 116 may be stored into the BTB 214. As previously explained, the technique also comprises storing the program counter of the non-predicated instruction immediately preceding the group 118 (i.e., program counter “2” of non-predicated instruction 102). Thus, in all, the BTB 214 comprises the program counters of the non-predicated instruction immediately preceding the group 118 (in the example above, program counter “2”) and the first non-predicated instruction after the group 118 (in the example above, program counter “6”). In future iterations of instruction set 10, the BTB 214 preferably uses these two program counters to branch over (i.e., skip) the group 118 as described below when it is determined that the group 118 does not need to be executed.

Referring still to FIGS. 1 and 2, in a subsequent iteration of instruction set 10, the instruction set 10 may begin to be processed as in the first iteration. However, when an instruction having program counter “2” (e.g., the last non-predicated instruction prior to the group 118 (in this example, instruction 102)) is fetched from the icache 222 to be processed by the pipeline 208, the control logic 216 may use the BTB 214 to perform a branch prediction. In particular, based on the branch bias values stored in the storage unit 226, the control logic 216 may determine the likelihood that the conditional statement 106 (and thus the conditional statements 110, 114) will be true or false.

For example, if the branch bias values stored in the storage unit 226 are “1 1” (“strongly skipped”), then there is a substantial likelihood that the value of bit C will be “0,” which indicates the conditional statements 106, 110, 114 are likely to be false. In this case, processor time and power would be wasted fetching, decoding and executing each of the predicated instructions 104, 108, 112, only to discover that, because conditional statements 106, 110, 114 are false, the results of the predicated instructions 104, 108, 112 cannot be committed to storage. Thus, in this case, based on the substantial likelihood that the conditional statements 106, 110, 114 will be false and that the execution of predicated instructions 104, 108, 112 will be unnecessary, the control logic 216 appends a conditional branch instruction onto the instruction having program counter “2” (i.e., non-predicated instruction 102) before that instruction is accepted into the pipeline 208 or, in some embodiments, after the instruction is accepted into the pipeline 208. Thus, the instruction 102 is effectively converted into a conditional branch instruction. This instruction 102 may comprise a branch offset of “3,” calculated by the control logic 216 by determining the difference between the program counter of the first predicated instruction of the group 118 (i.e., program counter “3,” since the program counter is automatically incremented to point from program counter “2” to program counter “3”) from the program counter of the non-predicated instruction immediately succeeding the group 118 (i.e., program counter “6”).

Thus, each time the instruction 102 is decoded and/or executed, it will first be determined whether the condition associated with the instruction 102 is true or false (in the case of FIG. 1, whether the condition “C!=0” is true or false). If the condition is false, then the branch offset of “3” will be used to skip over the group 118. Thus, the next instruction to be fetched after non-predicated instruction 102 is non-predicated instruction 116. In this way, because the predicated instructions in group 118 were of no consequence and would needlessly have been executed, the group 118 is skipped, saving time and processing power. If the branch bias values stored in the storage unit 226 had been, for example, “0 0,” or “strongly not skipped,” then execution would have continued as normal.

In at least some embodiments, a minimum or maximum threshold number of consecutive, predicated instructions that are skipped may be programmed by, for example, a manufacturer. For instance, the manufacturer may determine that the time and power saved by not executing a group of two or fewer consecutive, predicated instructions may not be worth implementing the technique described above. Accordingly, in such a case, the processor 200 may be programmed not to implement the technique described above unless the number of consecutive, predicated instructions (having substantially similar or identical conditional statements) in a group is three or higher.

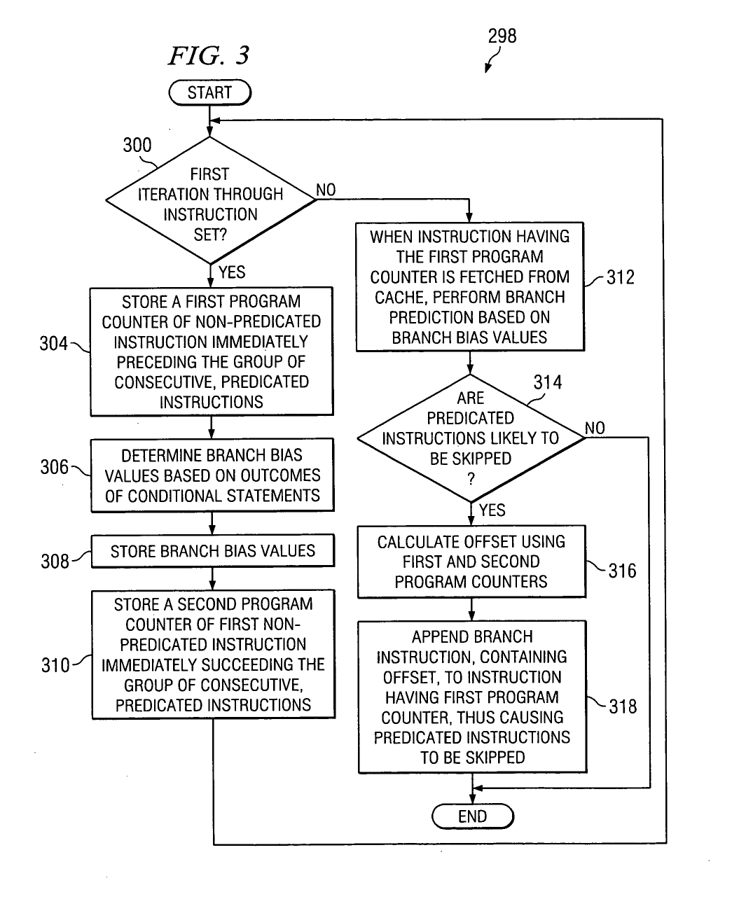

FIG. 3 shows a flow diagram of a method 298 that may be used to implement the technique described above. For a first iteration through an instruction set (block 300), the method 298 may comprise storing a first program counter (e.g., program counter “2”) that is the program counter of the non-predicated instruction (e.g., non-predicated instruction 102) immediately preceding the group 118 (block 304). At block 306, the method 298 may further comprise determining branch bias values for the conditional statement 106 (and thus for conditional statements 110, 114) based on the outcome of the conditional statements 106, 110, 114 (e.g., whether (C!=0) is true or false). The method 298 also comprises storing the branch bias values, for example, in the BTB 214 (block 308). In at least some embodiments, the branch bias values may be initialized to “1 0.” Finally, in the first iteration, the method 298 comprises storing a second program counter (e.g., program counter “6”) which is the program counter of the first non-predicated instruction immediately succeeding the group 118 (block 310).

In a second or subsequent iteration (block 300), the method 298 comprises performing a branch prediction, based on the branch bias values stored in the BTB 214, when the instruction (e.g., non-predication instruction 102) having the first program counter (e.g., program counter “2”) is fetched from the icache 222 (block 312). Specifically, the method 298 determines whether the predicated instructions in group 118 are likely to be skipped, given previous execution history indicated by the branch bias values (block 314). If group 118 is unlikely to be skipped, then processing continues as normal.

However, if the predicated instructions in group 118 indeed are likely to be skipped, then the method 298 comprises calculating an offset using the first and second program counters (block 316). The method 298 subsequently comprises appending a branch instruction to the instruction (e.g., non-predicated instruction 102) having the first program counter (e.g., program counter “2”) as soon as that instruction is fetched from the icache 222 (block 318). In some embodiments, the branch instruction may be appended to the instruction having the first program counter while that instruction is still in the icache 222. The branch instruction comprises an offset value that is used to skip over the group 118. In at least some embodiments, the offset value is determined by the module 202 by subtracting the second program counter from the first program counter. Also, in some embodiments, the branch prediction may be stored in the BTB 214 for future reference or, alternatively, the branch prediction may be used to modify the branch bias values in the storage unit 226. In at least some embodiments, the module 202 sends a target address to the instruction cache module 220 that redirects the instruction cache module 220 to the next proper instruction to be fetched and transferred to the pipeline 208 (i.e., instruction 116). The process is then complete.

The scope of disclosure is not limited to skipping over groups of predicated instructions 118 comprising instructions that are all predicated on the same CCR bit. In some embodiments, the instructions in the group 118 may be predicated on different CCR bits. For instance, in such embodiments, the predicated instruction 108 in group 118 of FIG. 1 may be predicated on bit V instead of bit C. Instead of converting the non-predicated instruction 102 into an instruction 102 predicated on bit C as in the example above, in such cases, the non-predicated instruction 102 is converted into an instruction 102 predicated on bit C as well as bit V. Thus, if the conditions (regardless of the CCR bit) associated with the instructions in group 118 are false, then the group 118 is skipped. Otherwise, the group 118 is processed. Further, some of the predicated instructions in the group 118 may be predicated on more than one condition. For instance, predicated instruction 104 may be predicated on the condition “C!=0,” as shown, but also may be predicated on a condition “Z!=0” (not shown).

Further, the scope of disclosure is not limited to instruction sets that comprise only one group of predicated instructions. An instruction set processed by the processor 200 may in fact comprise multiple, separate groups of predicated instructions. In such cases, the technique above may be individually applied to each group of predicated instructions. Thus, the storage units 210 may store program counters associated with each group of predicated instructions and may provide the program counters to the module 202 as necessary.

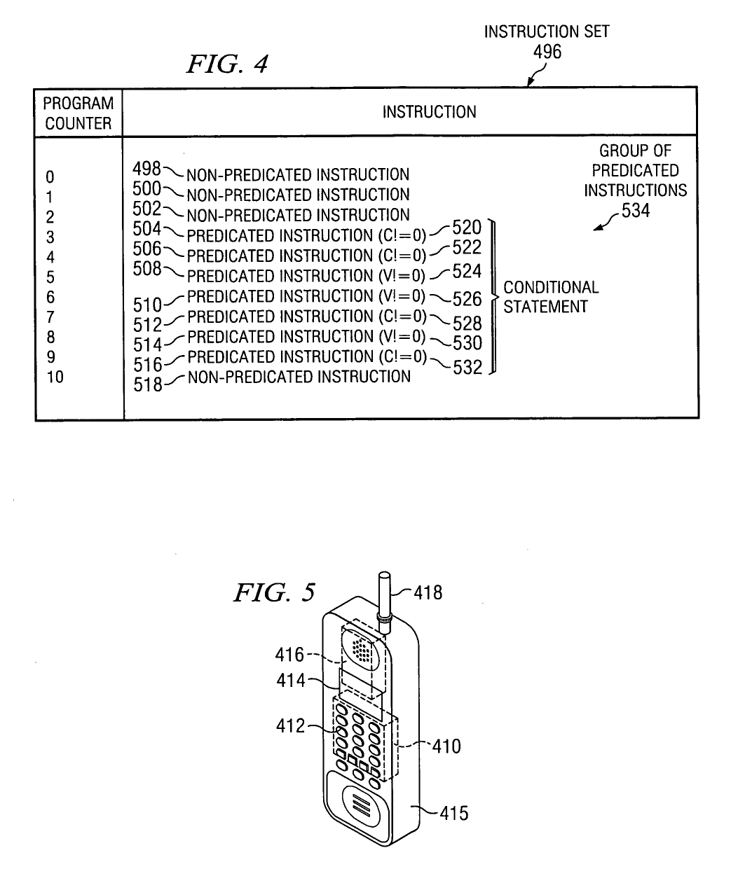

In some embodiments, binary masks may be used to skip over unnecessary predicated instructions. FIG. 4 shows an instruction set 496 virtually identical to instruction set 10 of FIG. 1, except instruction set 496 comprises a greater number of consecutive, predicated instructions, and these consecutive, predicated instructions are predicated on different CCR bits. More specifically, instruction set 496 comprises a non-predicated instruction 498 having program counter “0,” a non-predicated instruction 500 having program counter “1,” a non-predicated instruction 502 having program counter “2,” a predicated instruction 504 having program counter “3” and predicated on condition 520 (i.e., “C!=0”), a predicated instruction 506 having program counter “4” and predicated on condition 522 (i.e., “C!=0”), a predicated instruction 508 having program counter “5” and predicated on condition 524 (i.e., “V!=0”), a predicated instruction 510 having program counter “6” and predicated on condition 526 (i.e., “V!=0”), a predicated instruction 512 having program counter “7” and predicated on condition 528 (i.e., “C!=0”), a predicated instruction 514 having program counter “8” and predicated on condition 530 (i.e., “V!=0”), a predicated instruction 516 having program counter “9” and predicated on condition 532 (i.e., “C!=0”) and a non-predicated instruction 518 having program counter “10.” Predicated instructions 504-516 make up a group of predicated instructions 534.

Instead of appending a branch instruction to non-predicated instruction 502 as in the embodiments described above, in embodiments using binary masks, the control logic 216 may append a binary mask to non-predicated instruction 502. The binary mask is created by the control logic 216 based on the predicted values of the conditional statements 520-532. In instruction set 496, assume that C=0 and V!=0. Thus, conditional statements 520, 522, 528 and 532 would be false, and conditional statements 524, 526 and 530 would be true. Accordingly, the control logic 216 may generate a binary mask, such as “0011010.” Each bit of this binary mask applies to an instruction including and after instruction 504, in sequential order. Thus, because instruction 504 is skipped (i.e., since statement 520 is false), instruction 504 is assigned a “0” in the binary mask. Because instruction 506 also is skipped, it also is assigned a “0” in the mask. Because instruction 508 is true, however, it is not skipped, and thus it is assigned a “1” in the mask, and so forth. In this way, after appending the mask to the instruction 502, when the instruction 502 is next processed, some of the predicated instructions in the group 534 are selectively skipped, while others are not. In at least some embodiments, the mask may be more complex and may incorporate condition checks for each bit of the mask. For instance, in the above example, an additional condition check may be performed while instruction 508 is being processed, to determine whether to skip over the next instruction (i.e. instruction 512). Such an embodiment may be useful in situations where a single mask applied to instruction 502 may not suffice, since the CCR bits may change during execution of the instructions in the group 534.

FIG. 5 shows an illustrative embodiment of a system comprising the features described above. The embodiment of FIG. 5 comprises a battery-operated, wireless communication device 415. As shown, the communication device 415 includes an integrated keypad 412 and a display 414. The processor 200 may be included in an electronic package 410 which may be coupled to keypad 412, display 414 and a radio frequency (RF) transceiver 416. The RF circuitry 416 preferably is coupled to an antenna 418 to transmit and/or receive wireless communications. In some embodiments, the communication device 415 comprises a cellular (e.g., mobile) telephone.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A processor, comprising:
an instruction cache module adapted to store a plurality of instructions, said plurality of instructions comprising a group of instructions predicated on a conditional statement; and
a branch prediction module coupled to the instruction cache module and adapted to predict an outcome of the conditional statement;
wherein, based on said prediction, the branch prediction module modifies an instruction preceding the group of instructions such that at least one instruction in said group of instructions is not executed.

2. The processor of claim 1, wherein the branch prediction module modifies the instruction preceding the group of instructions by applying a binary mask to said instruction preceding the group of instructions.

3. The processor of claim 1, wherein the instruction preceding the group of instructions immediately precedes said group of instructions.

4. The processor of claim 1, wherein at least two instructions in said group of instructions are predicated on different conditional statements.

5. The processor of claim 1, wherein the number of instructions that are not executed is programmable.

6. The processor of claim 1, wherein the conditional statement comprises a condition code register (CCR) bit.

7. The processor of claim 1, wherein the branch prediction module modifies the instruction preceding the group using a conditional branch instruction.

8. A system, comprising:
a transceiver; and
a processor coupled to the transceiver and comprising:
a cache module adapted to store a plurality of instructions, a group of the plurality of instructions predicated on at least one condition; and
a prediction module coupled to the cache module, said prediction module adapted to predict the status of the at least one condition and, based on said prediction, to determine whether to skip over at least some of the group.

9. The system of claim 8, wherein multiple groups of the plurality of instructions are predicated on the at least one condition;
wherein the prediction module is adapted to, based on said prediction, determine whether to skip over at least some of at least one of said multiple groups.

10. The system of claim 8, wherein the system comprises one of a wireless communication device or a battery-operated device.

11. The system of claim 8, wherein the prediction module alters an instruction preceding the group such that, after the instruction preceding the group is processed, at least some of the group is skipped.

12. The system of claim 11, wherein the prediction module alters the instruction preceding the group using a program counter of said instruction preceding the group and a program counter of an instruction succeeding the group.

13. The system of claim 8, wherein the group comprises a plurality of instructions, each instruction in the group predicated on the same condition.

14. The system of claim 8, wherein the group comprises a plurality of instructions, at least some of the instructions in the group predicated on different conditions.

15. The system of claim 8, wherein the group comprises a plurality of instructions, at least one of the instructions in the group predicated on more than one condition.

16. A method, comprising:
predicting the outcome of a conditional statement contained within a predicated instruction; and
based on said prediction, determining whether to skip over at least part of a group of predicated instructions all predicated on the conditional statement.

17. The method of claim 16 further comprising skipping over the at least part of the group;
wherein skipping over the at least part of the group comprises using a program counter of an instruction preceding said group and a program counter of an instruction succeeding said group.

18. The method of claim 16 further comprising modifying an instruction preceding the group.

19. The method of claim 18, wherein modifying the instruction preceding the group comprises using a conditional branch instruction.

20. The method of claim 18, wherein modifying the instruction preceding the group comprises using a binary mask.
